(19) United States
(12) Patent Application Publication
(10) Pub. No.: US 2022/0288851 A1
(43) Pub. Date: Sep. 15, 2022

(54) NOZZLE AND MODELING DEVICE

(71) Applicant: MITSUBISHI HEAVY INDUSTRIES, LTD., Tokyo (JP)

(72) Inventors: Makoto INOMOTO, Tokyo (JP); Wataru NISHIMURA, Tokyo (JP)

(21) Appl. No.: 17/587,464

(22) Filed: Jan. 28, 2022

(30) Foreign Application Priority Data
Mar. 9, 2021 (JP) 2021-037429

(51) Int. Cl. B29C 64/321; B29C 64/129; B29C 64/314

(52) U.S. Cl. CPC B29C 64/321; B29C 64/129; B29C 64/314; B29K 2101/10

(57) ABSTRACT

A nozzle of a modeling device that discharges a resin material, the nozzle including a resin flow path extending from a feed portion to a discharge port along a resin flow path axis and guiding the resin material and a vent flow path that enables the resin flow path to communicate with the outside of the nozzle. Further, a heater is provided in a periphery of the resin flow path, the heater being capable of heating the resin material guided by the resin flow path, and the vent flow path communicates with the resin flow path located downstream of the heater in the direction in which the resin material advances.

### CROSS-REFERENCE TO RELATED APPLICATIONS

This application claims the benefit of priority to Japanese Patent Application Number 2021-037429 filed on Mar. 9, 2021. The entire contents of the above-identified application are hereby incorporated by reference.

### TECHNICAL FIELD

The disclosure relates to a nozzle and a modeling device.

### RELATED ART

Resin AM technology is used in a wide range of applications from the field of rapid prototyping, such as production of prototype parts, to direct digital manufacturing (DDM), such as production of final-version parts.

In particular, the fused filament fabrication (FFF) method, in which a melted resin material is discharged from a nozzle and layered, is used in a variety of ways because the structure thereof is simple and a variety of resin materials can be used (see, for example, JP 2020-157752 A).

### SUMMARY

On the other hand, the FFF method is known to be susceptible to internal defects (e.g., voids) in modeled products.

The two main causes of voids are as follows. The first cause is due to gaps in modeling beads, and the second cause is due to gas entering a discharged resin material.

The first cause can be mitigated by adjusting the amount of a resin material discharged and by devising a path. However, the second cause cannot be easily mitigated and there is a need for some improvements in the device.

In light of the foregoing, an object of the disclosure is to provide a nozzle and a modeling device that allow for reducing the possibility of gas entering a discharged resin material.

To solve the above-described problem, the nozzle and the modeling device of the disclosure adopt the following technique.

That is, a nozzle according to one aspect of the disclosure is a nozzle of a modeling device that discharges a resin material, the nozzle including a resin flow path extending along an axis from a feed portion to a discharge port and guiding the resin material, and a communicating flow path that enables the resin flow path to communicate with the outside of the nozzle.

In addition, a modeling device according to one aspect of the disclosure includes the above-described nozzle.

According to the disclosure, the possibility of gas entering the discharged resin material can be reduced.

### BRIEF DESCRIPTION OF DRAWINGS

The disclosure will be described with reference to the accompanying drawings, wherein like numbers reference like elements.

FIG. 1 is a configuration diagram of a modeling device according to a first embodiment of the disclosure.

FIG. 2 is a vertical cross-sectional view of a nozzle according to the first embodiment of the disclosure.

FIG. 3 is a horizontal cross-sectional view taken along the line illustrated in FIG. 2.

FIG. 4 is a vertical cross-sectional view of a nozzle guiding a resin material.

FIG. 5 is a vertical cross-sectional view of a nozzle according to a second embodiment of the disclosure.

FIG. 6 is a vertical cross-sectional view of a nozzle according to a third embodiment of the disclosure.

FIG. 7 is a vertical cross-sectional view of a nozzle according to a fourth embodiment of the disclosure.

### DESCRIPTION OF EMBODIMENTS

### First Embodiment

A nozzle and a modeling device according to the first embodiment of the disclosure will be described below with reference to the drawings.

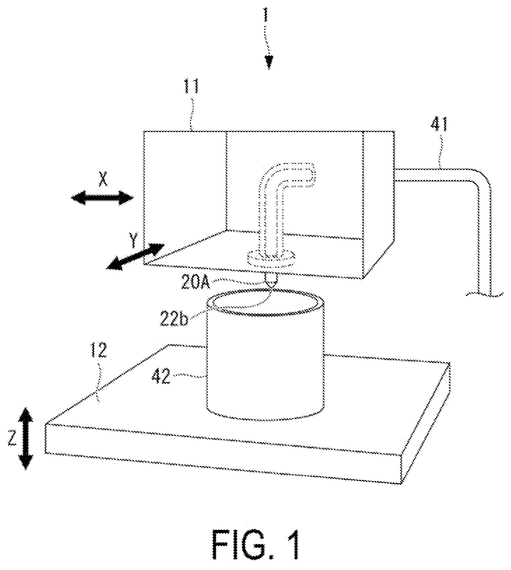

As illustrated in FIG. 1, a modeling device 1 includes a modeling head 11 and a modeling table 12. The modeling device 1 is, for example, a three-dimensional modeling device of the FFF method.

A resin material 41 having an elongated string-like shape is fed to the modeling head 11. Examples of the resin material 41 include nylon, ABS resin, Polylactic Acid (PLA), and Poly Ether Imide (PEI).

The resin material 41 that has been fed is discharged from a nozzle 20A provided in the modeling head 11. The nozzle 20A is provided in the modeling head 11 with a distal end (discharge port 22b) facing the modeling table 12 side.

The resin material 41 discharged from the nozzle 20A is layered on the modeling table 12 to model a modeled product 42 having a desired shape.

The modeling head 11 is movable in an X direction and a Y direction illustrated in FIG. 1. Additionally, the modeling table 12 is movable in a Z direction illustrated in FIG. 1. Accordingly, the modeling head 11 and the modeling table 12 are movable in a relatively three-dimensional manner.

Note that the movement directions of the modeling head 11 and the modeling table 12 are not limited to the above-described directions as long as the modeling head 11 and the modeling table 12 are movable in a relatively three-dimensional manner.

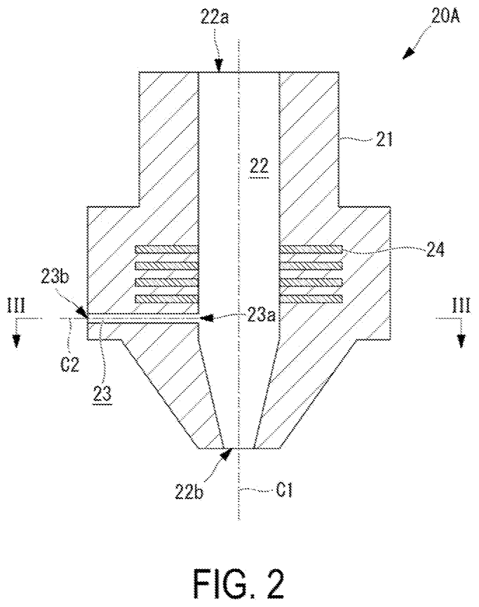

As illustrated in FIG. 2, the nozzle 20A includes a nozzle main body 21, a resin flow path 22, a vent flow path (communicating flow path) 23, and a heater (heating portion) 24.

The nozzle main body 21 is made of a metal (for example, brass for a resin without filler, carbon steel for a resin with filler). The nozzle main body 21 defines the resin flow path 22 and the vent flow path 23 therein. In other words, the resin flow path 22 and the vent flow path 23 are flow paths formed by the nozzle main body 21.

The resin flow path 22 includes a feed portion 22a on a base end side and a discharge port 22b on a distal end side, and extends from the feed portion 22a to the discharge port 22b along a resin flow path axis (axis) C1.

The resin flow path 22 guides the resin material 41 fed to the feed portion 22a via the modeling head 11 to the discharge port 22b.

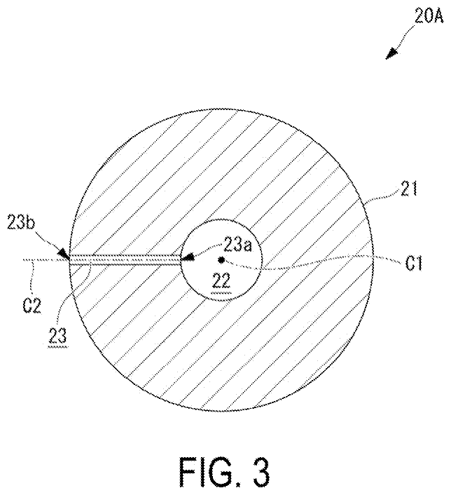

As illustrated in FIG. 3, the horizontal cross-sectional shape of the resin flow path 22 is, for example, circular. In addition, as illustrated in FIG. 2, the inside diameter of the resin flow path 22 is constant in a predetermined range from the feed portion 22a along the resin flow path axis C1, and then tapers toward the discharge port 22b.

The heater 24 is provided in the nozzle main body 21 in a periphery of the resin flow path 22. The heater 24 is provided in a portion on the feed portion 22a side (the range in which the inside diameter is constant) than the tapered portion of the resin flow path 22.

The heater 24 heats the nozzle main body 21 that defines the resin flow path 22. Thus, the resin material 41 guided by the resin flow path 22 is heated.

As illustrated in FIGS. 2 and 3, the vent flow path 23 includes a communicating opening 23a in the resin flow path 22 and an opening 23b on an outer surface of the nozzle main body 21, and extends from the feed portion 22a to the discharge port 22b along a vent flow path axis C2 extending in a radial direction of the resin flow path axis C1. The vent flow path 23 connects the resin flow path 22 and the outside of the nozzle 20A.

The communicating opening 23a is located, in a direction in which the resin material 41 advances, downstream of the heater 24 and upstream of the tapered portion of the resin flow path 22.

The vent flow path 23 has a horizontal cross-sectional shape that is, for example, circular, and has an inside diameter that is constant throughout an entire range along the vent flow path axis C2.

Here, the inside diameter of the vent flow path 23 is sufficiently small compared to the inside diameter of the resin flow path 22 (the inside diameter in the range where the dimension is constant), and is, for example, approximately from 0.1 mm to 0.3 mm. Thus, a viscous resin material 41 (melted resin material 41) is less likely to enter the vent flow path 23 from the communicating opening 23a.

Note that, in a case illustrated in FIG. 3, only one vent flow path 23 is provided, but a plurality thereof may be provided in a radial manner about the resin flow path axis C1.

In the above-described configuration, the resin material 41 is discharged from the nozzle 20A as follows.

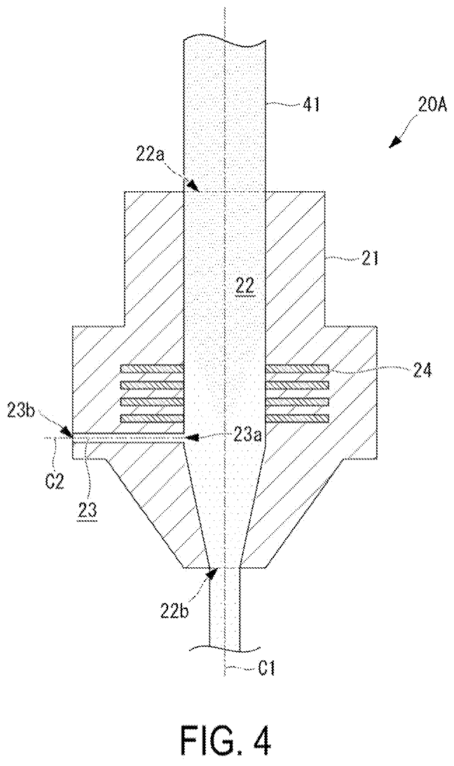

That is, as illustrated in FIG. 4, the resin material 41 fed to the feed portion 22a advances toward the discharge port 22b. Here, the resin material 41 is melted by the heater 24. Thus, the resin material 41 fed in a solid state is discharged from the discharge port 22b in a melted state.

Here, moisture may be contained in the resin material 41, and this moisture vaporizes by an increase in the temperature of the resin material 41. A gas generated by vaporization enters the melted resin material 41 in the resin flow path 22. The gas mixed into the melted resin material 41 causes voids in the modeled product 42.

Hence, in the present embodiment, by providing the vent flow path 23, gas mixed into the resin material 41 is discharged from the resin flow path 22 to the outside of the nozzle 20A.

The process of discharging the gas mixed into the resin material 41 will be described below.

A gas has a high diffusion coefficient in the melted resin material 41. Accordingly, the gas mixed into the resin material 41 tends to move toward an inner peripheral wall defining the resin flow path 22 (movement by diffusion).

The gas that has moved toward the inner peripheral wall enters the vent flow path 23 from the communicating opening 23a, and is discharged from the opening 23b.

According to the above-described process, the gas mixed into the resin material 41 is discharged from the resin flow path 22 to the outside of the nozzle 20A via the vent flow path 23.

According to the present embodiment, the following effects are obtained.

Providing the vent flow path 23, which communicates with the resin flow path 22 and the outside of the nozzle 20A, allows the gas mixed into the resin material 41 to be discharged from the resin flow path 22 to the outside of the nozzle 20A via the vent flow path 23. This reduces the possibility of gas entering the resin material 41 discharged from the discharge port 22b. This, in turn, can reduce the possibility of void formation inside the modeled product 42.

Additionally, the vent flow path 23 communicates with the resin flow path 22 located downstream of the heater 24 in the direction in which the resin material 41 advances, and thus a portion of the resin flow path 22 where the resin material 41 is reliably melted can communicate with the outside of the nozzle 20A via the vent flow path 23.

### Second Embodiment

A nozzle and a modeling device according to the second embodiment of the disclosure will be described below with reference to the drawings.

Note that a nozzle 20B of the present embodiment is identical with the nozzle 20A of the first embodiment except in the configuration of the vent flow path 23. Thus, the same components are denoted by the same reference signs, and descriptions thereof will be omitted.

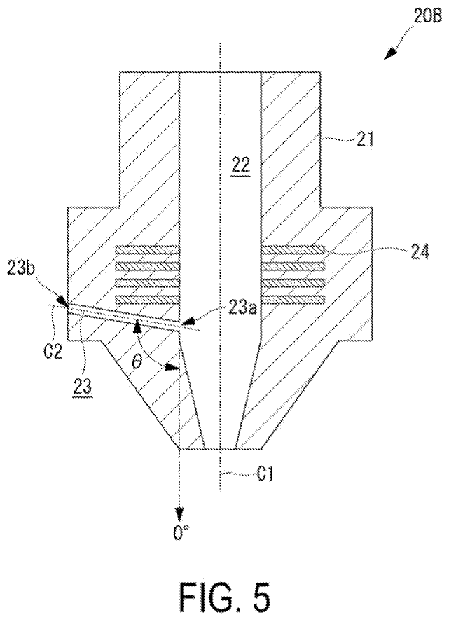

As illustrated in FIG. 5, the vent flow path 23 (vent flow path axis C2) is inclined upward from the communicating opening 23a toward the opening 23b.

Here, when the direction in which the resin material advances along the resin flow path axis C1 is 0°, an inclination angle θ of the vent flow path 23 (vent flow path axis C2) is set to, for example, 90° or more and 135° or less.

According to the present embodiment, the following effects are obtained.

The vent flow path 23 has an inclination angle of 90° or more and 135° or less, and thus the vent flow path 23 can be inclined against the direction in which the resin material 41 advances. Here, an inertial force acts on the resin material 41 toward the direction in which the resin material 41 advances. In other words, the resin material 41 will keep flowing in the direction in which the resin material 41 advances. Thus, by inclining the vent flow path 23 as described above, the possibility of the melted resin material 41 leaking from the resin flow path 22 to the outside of the nozzle 20B via the vent flow path 23 can be reduced (so-called vent up suppression).

### Third Embodiment

A nozzle and a modeling device according to the third embodiment of the disclosure will be described below with reference to the drawings.

Note that a nozzle 20C of the present embodiment is identical with the nozzle 20A of the first embodiment except in the configuration of the resin flow path 22. Thus, the same components are denoted by the same reference signs, and descriptions thereof will be omitted.

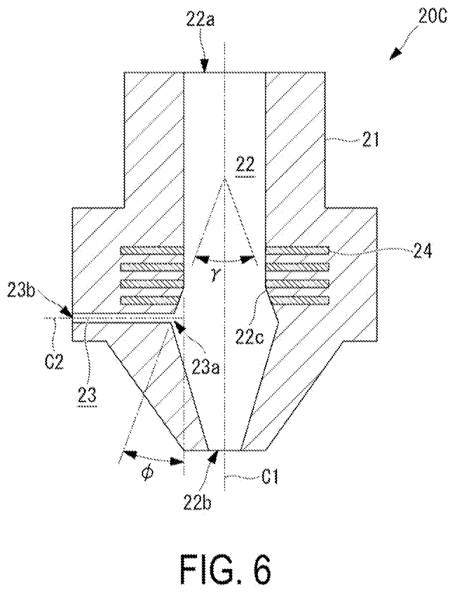

As illustrated in FIG. 6, the resin flow path 22 includes a flow path enlarged portion 22c.

The flow path enlarged portion 22c is a portion configured such that the flow path area expands from upstream to downstream in the direction in which the resin material 41 advances.

The flow path enlarged portion 22c is composed of, for example, a tapered surface formed around an entire circumference about the resin flow path axis C1.

A slope angle φ of the tapered surface is preferably 5° or more and 30° or less. In other words, a taper angle γ of the tapered surface is preferably 10° or more and 60° or less.

The resin flow path 22 as such includes the communicating opening 23a disposed so as to face the flow path enlarged portion 22c. Thus, the vent flow path 23 communicates with the flow path enlarged portion 22c.

According to the present embodiment, the following effects are obtained.

The vent flow path 23 communicating with the flow path enlarged portion 22c lowers the pressure of the resin material 41 melted in the flow path enlarged portion 22c, and having the vent flow path 23 communicating with the flow path enlarged portion 22c can reduce the possibility of the resin material 41 leaking from the resin flow path 22 to the outside of the nozzle 20 C via the vent flow path 23 (so-called vent up suppression).

Additionally, by setting the slope angle of the tapered surface to 5° or more, the pressure of the melted resin material can be sufficiently reduced. Also, by setting the slope angle of the tapered surface to 30° or less, the possibility of the stagnation of the resin material can be reduced. When a slope angle of the tapered surface is 30° or more, the flow of the resin material 41 may separate at the beginning of the tapered surface. In this case, a separation vortex occurs, resulting in the possibility of a stagnation.

### Fourth Embodiment

A nozzle and a modeling device according to the fourth embodiment of the disclosure will be described below with reference to the drawings.

Note that a nozzle 20D of the present embodiment is identical with the nozzle 20A of the first embodiment except in the configuration of the resin flow path 22. Thus, the same components are denoted by the same reference signs, and descriptions thereof will be omitted.

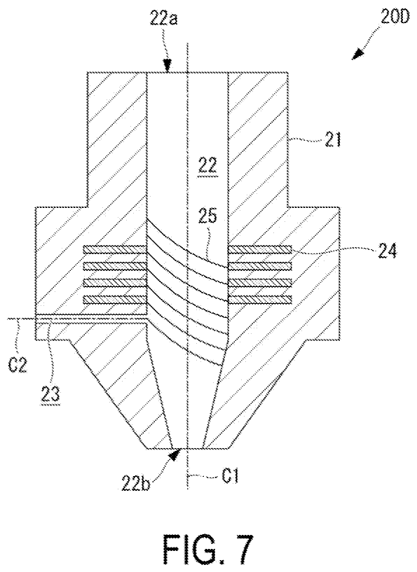

As illustrated in FIG. 7, a groove 25 formed into a spiral shape about the resin flow path axis C1 is provided in a peripheral wall defining the resin flow path 22. The groove 25 causes the melted resin material 41 to flow in a spiral manner.

According to the present embodiment, the following effects are obtained.

The groove 25 formed into the spiral shape causes the resin material 41 advancing through the resin flow path 22 to flow in a spiral manner. Thus, the gas mixed into the resin material 41 moves not only by diffusion but also by the flow of the resin material 41. This further facilitates discharge of the gas mixed into the resin material 41.

Note that the configurations of the nozzles according to the first to fourth embodiments can be combined as desired. For example, the groove 25 may be provided in the resin flow path 22 including the flow path enlarged portion 22c, or the groove 25 may be provided in the resin flow path 22 with which the inclined vent flow path 23 communicates.

The above-described embodiments can be understood, for example, as follows.

That is, a nozzle (20A, 20B, 20C, or 20D) according to one embodiment of the disclosure is a nozzle of a modeling device (1) that discharges a resin material (41). The nozzle includes a resin flow path (22) extending along an axis (C1) from a feed portion (22a) to a discharge port (22b) and guiding the resin material, and a communicating flow path (23) that enables the resin flow path to communicate with the outside of the nozzle.

The nozzle according to the present aspect includes the resin flow path extending from the feed portion to the discharge port along the axis and guiding the resin material, and the communicating flow path that enables the resin flow path to communicate with the outside of the nozzle, and thus the nozzle can discharge gas mixed into the resin material from the resin flow path to the outside of the nozzle via the communicating flow path. This can reduce the possibility of gas entering the resin material discharged from the discharge port. This, in turn, can reduce the possibility of void formation inside the modeled product.

Furthermore, the nozzle according to one aspect of the disclosure (20A, 20B, 20C, or 20D) further includes a heating portion (24) in a periphery of the resin flow path, the heating portion being capable of heating the resin material guided by the resin flow path, and the communicating flow path communicates with the resin flow path located downstream of the heating portion in a direction in which the resin material advances.

The nozzle according to the present aspect includes the heating portion in the periphery of the resin flow path, the heating portion being capable of heating the resin material guided by the resin flow path, and the communicating flow path communicates with the resin flow path located downstream of the heating portion in the direction in which the resin material advances. Thus, the portion of the resin flow path where the resin material is reliably melted and the outside of the nozzle can communicate with each other via the communicating flow path.

Further, in the nozzle (20B) according to one aspect of the disclosure, when the direction in which the resin material advances in the direction of the axis is 0°, the communicating flow path has an inclination angle of 90° or more and 135° or less.

In the nozzle according to the present aspect, the communicating flow path has an inclination angle of 90° or more and 135° or less when the direction in which the resin material advances in the direction of the axis is 0°. Thus, the communicating flow path can be inclined against the direction in which the resin material advances. Here, an inertial force acts on the resin material in the direction in which the resin material advances. That is, the resin material will keep flowing toward the direction in which the resin material advances. Thus, by inclining the communicating flow path as described above, the possibility of the melted resin material leaking from the resin flow path to the outside of the nozzle via the communicating flow path can be reduced.

In addition, in the nozzle (20C) according to one aspect of the disclosure, the resin flow path includes a flow path enlarged portion (22c) having a flow path area that expands from upstream to downstream, and the communicating flow path communicates with the flow path enlarged portion.

In the nozzle according to the present aspect, the resin flow path has the flow path enlarged portion in which the flow path area expands from upstream to downstream, and the communicating flow path communicates with the flow path enlarged portion. Thus, the pressure of the resin material melted in the flow path enlarged portion can be reduced. Also, by having the communicating flow path communicating with the flow path enlarged portion, the possibility of the resin material leaking from the resin flow path to the outside of the nozzle via the communicating flow path can be reduced.

In addition, in the nozzle (20C) according to one aspect of the disclosure, the flow path enlarged portion has a tapered surface that expands along a direction in which the resin material advances, and the tapered surface has a slope angle of 5° or more and 30° or less.

In the nozzle according to the present aspect, the flow path enlarged portion has a tapered surface that expands along the direction in which the resin material advances, and the tapered surface has a slope angle of 5° or more, and thus the pressure of melted resin material can be reduced. Also, the tapered surface has a slope angle of 30° or less, and thus the possibility of stagnation of resin material can be reduced.

In addition, in the nozzle (20D) according to one aspect of the disclosure, a groove (25) formed into a spiral shape about the axis is provided in a peripheral wall defining the resin flow path.

In the nozzle according to the present aspect, a peripheral wall defining the resin flow path is provided with a groove formed into a spiral shape about an axis, and thus the resin material that advances through the resin flow path flows in a spiral manner. This causes gas mixed into the resin material to move not only by diffusion but also by the flow of the resin material. Accordingly, the gas mixed into the resin material is more easily discharged.

In addition, a modeling device according to one aspect of the disclosure includes the above-described nozzle.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A nozzle of a modeling device that discharges a resin material, the nozzle comprising:
a resin flow path extending along an axis from a feed portion to a discharge port and guiding the resin material; and
a communicating flow path that enables the resin flow path to communicate with an outside of the nozzle.

2. The nozzle according to claim 1, further comprising:
a heating portion in a periphery of the resin flow path, the heating portion being capable of heating the resin material guided by the resin flow path, wherein
the communicating flow path communicates with the resin flow path located downstream of the heating portion in a direction in which the resin material advances.

3. The nozzle according to claim 1, wherein, when the direction in which the resin material advances along a direction of the axis is 0°, the communicating flow path has an inclination angle of 90° or more and 135° or less.

4. The nozzle according to claim 1, wherein
the resin flow path comprises a flow path enlarged portion having a flow path area that expands from upstream to downstream, and
the communicating flow path communicates with the flow path enlarged portion.

5. The nozzle according to claim 4, wherein
the flow path enlarged portion has a tapered surface expanding along the direction in which the resin material advances, and
the tapered surface has a slope angle of 5° or more and 30° or less.

6. The nozzle according to claim 1, wherein a groove formed into a spiral shape about the axis is provided in a peripheral wall defining the resin flow path.

7. A modeling device comprising:
the nozzle according to claim 1.
